(19) United States
(12) Patent Application Publication
(10) Pub. No.: US 2008/0126054 A1
(43) Pub. Date: May 29, 2008

(54) Discrete event system simulation interface

(76) Inventor: Moshe Asher Cohen, Jerusalem (IL)

Correspondence Address: BACON & THOMAS, PLLC, 625 SLATERS LANE, FOURTH FLOOR, ALEXANDRIA, VA, 22314, US

(21) Appl. No.: 11/604,776

(22) Filed: Nov. 28, 2006

(51) Int. Cl. G06F 17/50

(52) U.S. Cl. 703/13

(57) ABSTRACT

A method of building discrete system simulations, comprising a sequential set of questions asked of the author of the system, the inclusion of said questions being dependent upon answers to preceding questions and thus context-sensitive, comprising steps of implementing said sequence in software as an interactive process and skipping any steps that are irrelevant in view of earlier input. The method further comprises steps of providing an engine for a simplified, directed construction in logical top-down order of a model for simulation of a discrete-time system providing an engine for the conversion of a model created by a model-building apparatus to human-readable textual output that uniquely specifies the model.

### FIELD OF THE INVENTION

The present invention generally relates to a simulation interface for discrete event system simulations.

### BACKGROUND OF THE INVENTION

The invention relates to an interface for the construction of, running, and validation of simulators of discrete event systems. Discrete event system simulations are useful in industrial engineering, service system planning, traffic control, communication engineering, processor design, and process flow control in general. Such simulations are in general run on computers whose output can be yield conclusions about the simulated system. These simulations can reveal flaws or allow experimentation in the design of the system which can be tested ‘on paper’ before investing in the creation of an actual system, saving effort and cost.

U.S. Pat. No. 4,965,743 discloses a discrete event simulation tool for analysis of qualitative models of continuous processing systems. An artificial intelligence design and qualitative modeling tool is disclosed for creating computer models and simulating thereby continuous activities, functions and/or behavior using developed discrete event techniques. The tool is organized in four modules: a library design module, model construction module, simulation module, and experimentation and analysis module. The library design module supports the building of library knowledge including component classes and elements pertinent to a particular domain of continuous activities, functions, and behavior being modeled. The continuous behavior is defined discretely with respect to invocation statements, effect statements and time delays. The functionality of the components is defined in terms of variable cluster instances, independent processes and modes, further defined in terms of mode transition processes and mode dependent processes. Model construction utilizes the hierarchy of libraries and connects them with appropriate relations. The simulation executes a specialized initialization routine and executes events in a manner that includes selective inherency of characteristics through the library hierarchy and runs the events through a time and event schema until the event queue in the simulator is emptied. The experimentation and analysis module supports analysis through the generation of appropriate log files and graphics developments and includes the ability of log file comparisons.

However this system is not built to simulate discrete event systems but is rather intended to model continuous processing systems. Also the system is not necessarily user-friendly, and may in fact require a specialist that we refer to as a ‘simulation expert’ familiar with the design of such simulations to build it. Another person familiar with the system to be modeled, which we refer to as the ‘domain expert’, must use the experimentation and analysis module to verify and debug the system, causing a potential communication gap between the domain expert and the system expert. Consider the case where a simulation expert is called in by a company to create or improve a system simulation involving trade secrets or other confidential information. To protect its secrets the company may be forced to change elements of the simulation such that the simulation expert cannot learn this confidential information. In such cases the communication gap between the simulation expert and the domain expert may become severe. Furthermore the model's textual output does not constitute a complete description of the model, but rather is a log of the operations in one run of the simulation. It thus cannot be utilized by either expert as a textual description of the system for purposes of debugging but rather may only allow verification of the correctness of one particular run of the simulation, nor can it be used as input to generate a correct simulation by a textual description alone. Furthermore, sufficiently complex simulations may require the use of random number generation to simulate various random processes that may occur in the system to be simulated. In this case it is often desirable to use so-called antithetic or common stream techniques for the reduction of the variance of the simulation results over many trials. No provision is made in the aforementioned patent for the managing of such methods.

In U.S. Pat. No. 5,828,867 a method for discrete digital event simulation is introduced comprising a method for re-configuring a pre-compiled discrete-event digital simulation program. The method comprises the steps of creating a template having a series of generic tasks and incorporating the template onto a computer to create a generic computer simulation. Next information associated with the steps of a process are input on the computer. The information includes the time duration of each step and the resources expended in accomplishing each step. Finally, the step information is applied to the generic computer simulation to create the discrete event simulation model of the process.

However as in U.S. Pat. No. 4,965,743 the system will likely require a separate simulation expert and domain expert, allowing for the aforementioned debilitating communication gap between the simulation expert and the domain expert. No provision is made for automatic encryption of names and hiding of comments to protect the trade secrets inherent in the model. The model's textual output does not constitute a complete description of the model. Furthermore no provision is made for the use of antithetic variables or common-stream techniques to reduce model variance.

Hence, a system for the guided step by step building of a model of a discrete event system that does not require a simulation expert, allows for automatic encryption of names and removal of comments for protecting trade secrets, provides a precise natural language description of the model, and allows for simplified use of antithetic variables and/or common-stream techniques for reduction of simulation variance between runs is still a long felt need.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1 schematically presents a flow chart depicting the steps involved in building a discrete event simulation; and,

FIG. 2 presents dialog boxes exemplifying the ‘wizard’ process of successive entry of information for the building of an example model.

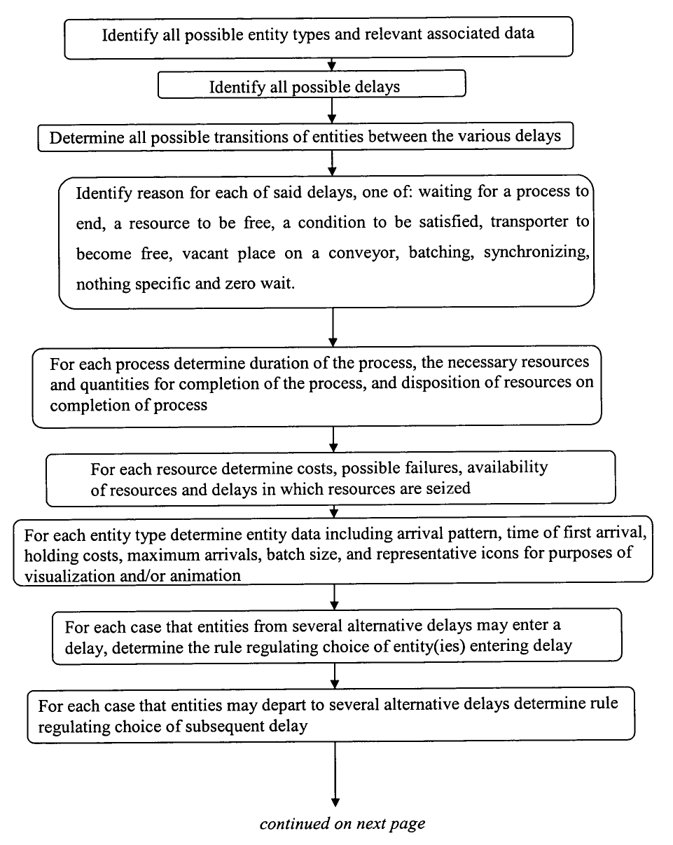

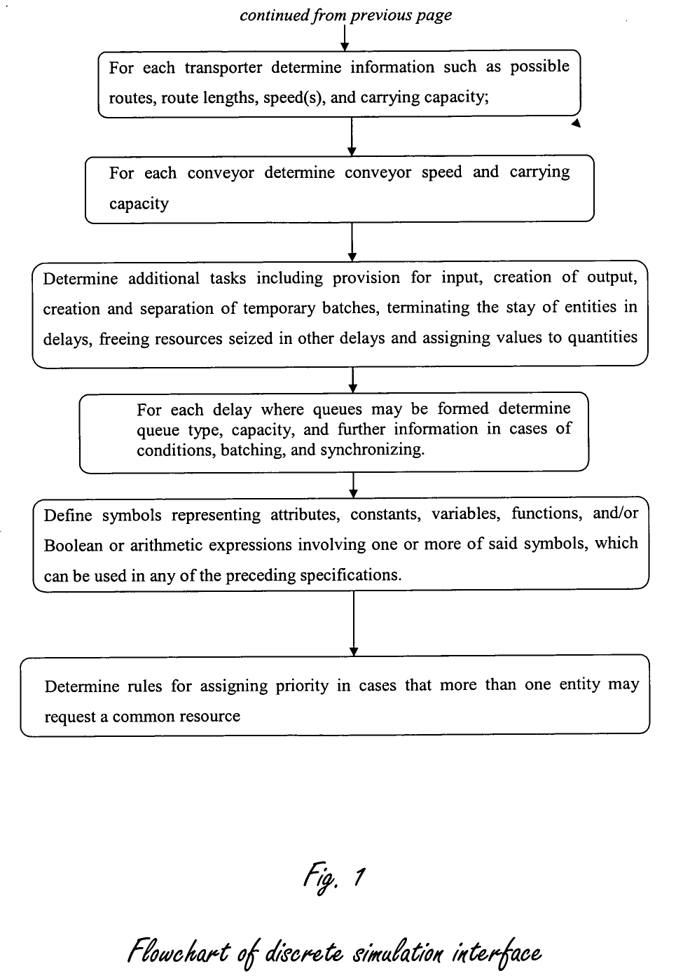

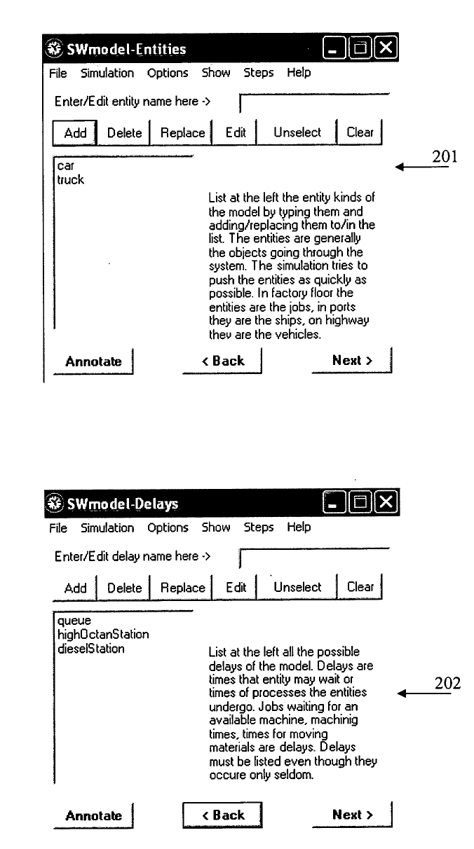

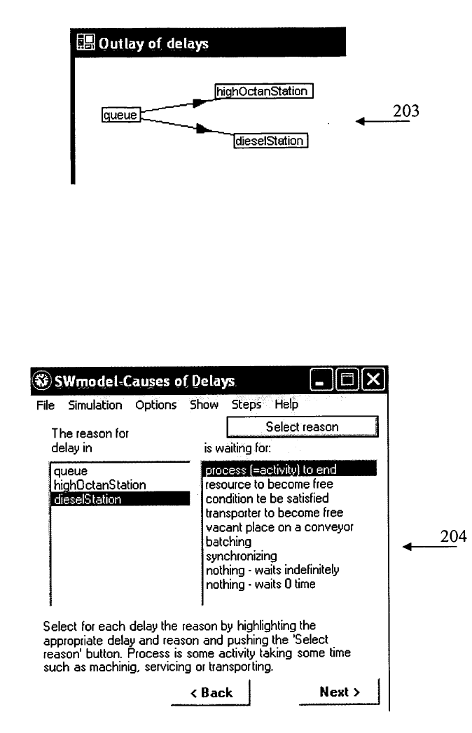

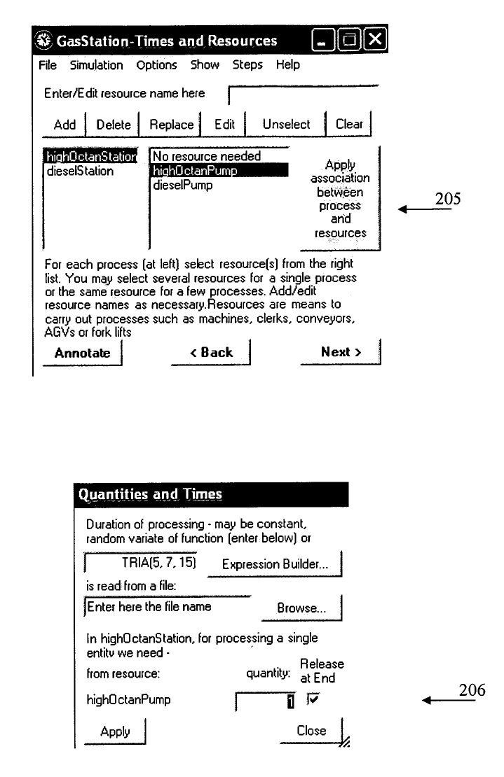

### SUMMARY OF THE INVENTION

It is one object of the present invention to disclose a method of building discrete system simulations, comprising a sequential set of questions asked of the author of the system, the inclusion of said questions being dependent upon answers to preceding questions and thus context-sensitive. The model author is prompted for determining all possible entity types relevant for the simulation; determining all possible delays that may occupy any of each of said entities; determining all possible transitions of entities between the various delays, preferably but not necessarily denoted as directed arcs in a graph where the delays are the nodes; determining the cause for each of the delays, said reasons being chosen from a close list of possible reasons; for all process-type delays, determining the duration of said processes and the necessary resources and quantities for completion of the processes, and disposing of resources on completion of a process; for all resource-type delays, data pertaining to said resources, consisting of costs, availability of resources and delays in which resources are seized, possible breakdowns, breakdown durations, and rules of governing the breakdowns; for all entities, data pertaining to the entity type, including arrival pattern, time of first arrival, holding costs, maximum arrivals, batch size, and representative icons for purposes of visualization and/or animation; for each case in which more than one entity originating from different delays may enter a given delay, a rule regulating the choice of entity or combination of entities entering the given delay; in the case where one entity must be chosen to enter the delay said choice being either random, ordered, defined by a function, or based on queue length, and in the case where a combination of entities may enter a delay, whether said combination is permanent, temporary, or comprised of batching any or specific entities; for each case where there exists a choice of subsequent delay upon completion of a given delay, rules regulating the choice of delay to take, said choice being based on entity type, predefined order, function evaluation, random choice, according to queue size if the destinations are queues, according to remaining capacities if the destination(s) are processes using resources, or indication that the entity is to be split and a copy sent to each possible subsequent delay; for each case of waiting for a transporter to become free, information about the transporter such as possible routes, route lengths, speed(s), and carrying capacity; for each case of waiting for a vacant place on a conveyor, information about the conveyor such as speed and carrying capacity; determine additional tasks not deduced from the above steps, including provision for input, creation of output, creation and separation of temporary batches, terminating the stay of entities in delays, freeing resources seized in other delays and assigning values to quantities or attributes, said tasks being executed either prior to entering or after leaving a delay; for all queue-type delays, namely waiting for a resource to become free, a condition to be satisfied, a transporter to become free, a vacant place on a conveyor, batching, or synchronizing, determine queue data including how entities are ordered in the queue such as first in-first out and other disciplines, capacity, and further information in cases of conditions, batching, and synchronizing; define symbols representing attributes, constants, variables, functions, stochastic state variables, and/or Boolean or arithmetic expressions involving one or more of said symbols, wherein said variables may be scalars, vectors, or arrays, as well as starting values for constants and variables, allowing the simulation author to freely make use of said symbols in any of the preceding specifications; and, determine rules for assigning priority in cases that more than one entity may request a common resource.

It is in the scope of the present invention wherein the method comprises steps of implementing said sequence in software as an interactive process, especially a ‘wizard’ prompting the user to enter the appropriate information at every step, and skipping any steps that are irrelevant in view of earlier input; occurring in the presented order or other possible orders such as step 8 of the sequence listed in the detailed description coming before step 5, or any other reordering consistent with the various steps' compulsory predecessors, and furthermore allowing for backtracking in the case of wrong or omitted data, and furthermore allowing for skipping to other parts.

It is also in the scope of the present invention wherein a method of model building is disclosed. The method comprises steps of providing an engine as defined in claim 1, for a simplified, directed construction in logical top-down order of a model for simulation of a discrete-time system by a person who is familiar with the system to be simulated but who is not necessarily familiar with the building of simulations; said method also providing an engine for the conversion of a model created by a model-building apparatus to human-readable textual output that uniquely specifies the model, eliminating possible misunderstandings by the person familiar with the system to be simulated as to the contents of the model.

It is in the scope of the present invention wherein the model building and natural-language output apparatus as defined in any of the above furthermore comprises a simulation engine for the simulation of the modeled system, as well as an engine for the exporting of said model to any number of standard formats allowing said model to be read and simulated by other simulator programs.

It is in the scope of the present invention wherein the discrete system model-builder and simulator as defined in any of the above furthermore allowing provision for the use of antithetic variables and the “common stream” method as an easily-accessed option, involving only indication in a single place that the user wants to use antithetic variables or the common-stream method, correctly and automatically places everywhere the seeds and for the antithetic method correctly and automatically computing the relevant statistic.

It is also in the scope of the present invention wherein the discrete system model-builder and simulator as defined in any of the above additionally providing for automatic encoding of names and hiding of remarks to satisfy the requirement for secrecy.

Simulation models are only a part of operation research models. Operation research models also include mathematical programming models. The same problem of gap exists between the model expert and domain expert in mathematical modeling as in simulation. The same remedy can be applied also to mathematical programming concerning a closed list of questions asked of the naïve domain expert user that elicits a correct model. It is thus within the scope of the present invention that the system being built could comprise a mathematical programming model instead of a discrete system simulation. In both cases the system elicits the correct model formulation from a naïve user by means of a sequential set of questions asked of the user, the inclusion of said questions being dependent upon answers to preceding questions and thus context-sensitive. Thus it is a natural extension of the system as presented thus far, to provide for the encoding of a mathematical programming model instead of (or in addition to) a discrete system simulation.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a discrete event system simulation interface.

Discrete event systems are systems in which the events that occur may be represented as a time-ordered list. These systems may be simulated by creating a model representing the various entities, delays, and transitions in the system. Software tools exist to create such simulations, but are either specific to a particular industry, or require the services of a simulation expert to operate, or both.

The main objective of the invention is to make a general simulation tool that is user-friendly enough that non-experts in simulation may easily create valid simulations.

The model formulation is made by a step by step procedure when the user performs simple tasks that are easy to do. These steps can be performed in principle without software at all when they are given as a sequence of instructions, but the preferred embodiment is an expert system-like ‘wizard’.

Besides the obvious advantage of not requiring a simulation expert to create simulations, this approach solves an associated problem, namely the communication gap between the simulation expert and the ‘domain expert’ or person familiar with the system to be modeled. Consider the case where a simulation expert is called in by a company to create or improve a system simulation involving trade secrets or other confidential information. To protect its secrets the company may be forced to change elements of the simulation such that the simulation expert cannot learn this confidential information. In such cases the communication gap between the simulation expert and the domain expert may become severe.

The communication gap disappears if the simulation tool is operated by the domain expert. To further ensure the elimination of this communication gap, the model is represented by a human-readable textual description. The same model that is human-readable also drives the simulation software. Such a human-readable textual model description is novel in simulations.

The human-readable model is formed by software as a text file. This text file is composed of a sequence of predefined sentence patterns with variable parts written in such a way that it reads naturally. Models can be formulated in any European language. Rigid rules are required due to the fact that it is read also by the computer to drive the simulation. The patent claim includes the rules that form the text.

In many cases the model may involve data that the organization wants to keep secret, but for various reasons the organization may want to share or compare its simulation with some factor outside the company. In this case the present invention provides for automatic coding of names and hiding of remarks to solve the problem of secrecy. When the model is initially formulated inside the organization the real name of the objects and remarks make the model easy to understand. As an option, names can be decoded so that the originals remain within the organization together with the removed remarks. The names are changed to random strings and can be reestablished as another option. The same option adds the remarks that were previously removed. The model with random strings and without remarks can then be safely sent outside the organization or sent in an unsecured network.

Another aspect of simulation involves statistical techniques necessary to minimize variability. Many models require the use of random factors. In this case the results of simulating a model will in general vary from run to run. The overall results may be analyzed by reference to average values, which will have some amount of variance. Techniques exist to minimize this variance, which reduces the number of simulation runs needed to arrive at a reliable average value. Minimizing variability demands appropriate choice of random number generation. There are no automatic ‘single click’ methods used today for random number generation aiming to reduce variance.

It is within the scope of the present invention that automatic random number generation supporting “antithetic” and “common stream” methods are supported. The method of antithetic variables involves performing simulations in pairs. One simulation of a given pair is performed using random numbers generated by a pseudo-random number generator. The other simulation of the pair uses the complements of these random numbers wherever they are found in the simulation. For instance if the regular simulation uses the (normalized) random numbers {0.1, 0.5, 0.9} then the complementary simulation uses the complementary numbers {0.9, 0.5, 0.1}. This technique has been proven to reduce the variance of the simulation output averages.

For the common-stream method over multiple runs, the same random number seed is used to seed a pseudo-random number generator.

While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

According to a preferred embodiment of the present invention, the method is comprised of a checklist or wizard that guides the user through the building of the model. This is done in a conceptually simple top-down order, starting with the most basic simulation elements (entities, delays, transitions of entities between delays, and reasons for delays) followed by more detailed information about each of these. The preferred embodiment comprises the following steps:
1) Determine all possible entity types relevant for the simulation.
2) Determine all possible delays that may occupy any of each of said entities.
3) Determine all possible transitions of entities between the various delays, preferably but not necessarily denoted as directed arcs in a graph where the delays are the nodes.
4) Determine the cause for each of the delays, said reasons being chosen from the following list of possible reasons:
   {1} a process to end,
   {2} a resource to become free,
   {3} a condition to be satisfied,
   {4} a transporter to become free,
   {5} a vacant place on a conveyor,
   {6} batching,
   {7} synchronizing,
   {8} nothing—waiting indefinitely,
   {9} nothing—waiting 0 time.
5) For all process-type delays, the duration of said processes and the necessary resources and quantities for completion of the processes, and disposition of resources on completion of a process.
6) For all resource-type delays, data pertaining to said resources, consisting of costs, availability of resources and delays in which resources are seized, possible breakdowns, breakdown durations, and rules of governing the breakdowns.
7) For all entities, data pertaining to the entity type, including arrival pattern and delay to which entity arrives first, time of first arrival, holding costs, maximum arrivals, batch size, and representative icons for purposes of visualization and/or animation.
8) For each case in which more than one entity originating from different delays may enter a given delay, a rule regulating the choice of entity or combination of entities entering the given delay, in the case where one entity must be chosen to enter the delay said choice being either random, ordered, defined by a function, or based on queue length, and in the case where a combination of entities may enter a delay, whether said combination is permanent, temporary, or comprised of batching any or specific entities.
9) For each case where there exists a choice of subsequent delay upon completion of a given delay, rules regulating the choice of delay to take, said choice being based on entity type, predefined order, function evaluation, random choice, according to queue size if the destinations are queues, according to remaining capacities if the destination(s) are processes using resources, or indication that the entity is to be split and a copy sent to each possible subsequent delay.
10) For each case of waiting for a transporter to become free, information about the transporter such as possible routes, route lengths, speed(s), and carrying capacity.
11) For each case of waiting for a vacant place on a conveyor, information about the conveyor such as speed and carrying capacity.
12) Determine additional tasks not deduced from the above steps, including provision for input, creation of output, creation and separation of temporary batches, terminating the stay of entities in delays, freeing resources seized in other delays and assigning values to quantities or attributes, said tasks being executed either prior to entering or after leaving a delay.
13) For all queue-type delays, namely waiting for a resource to become free, a condition to be satisfied, a transporter to become free, a vacant place on a conveyor, batching, or synchronizing, determine queue data including how entities are ordered in the queue such as first in-first out and other disciplines, capacity, and further information in cases of conditions, batching, and synchronizing.
14) Define symbols representing attributes, constants, variables, functions, stochastic state variables, and/or Boolean or arithmetic expressions involving one or more of said symbols, wherein said variables may be scalars, vectors, or arrays, as well as starting values for constants and variables, allowing the simulation author to freely make use of said symbols in any of the preceding specifications.
15) Determine rules for assigning priority in cases that more than one entity may request a common resource.

The order of information entry may differ from that presented above, and can occur in any of a variety of orders restricted only by the following chart which lists which steps most logically precede other steps. We note that in the preferred embodiment allowance is made for backtracking in the case of wrong or omitted data, and furthermore allowance is made for skipping to other parts at the whim of the user. The above order and the ‘most likely’ orders specified below may serve as guides to the preferred embodiments.

In the following table we also include an indication of cases where certain steps may be omitted as well as their compulsory predecessors.

TABLE 1

| Step | Predecessor(s) | When omitted |
|---|---|---|
| List of Entity Types | None | Never |
| List of Delays | List of Entity Types¹ | Never |
| Causes of Delays | List of Delays | Never |
| Duration and | Causes of Delays | No type {1} among delays |
| Resources | | |
| Resource Data | Duration and Resources | No resource needed anywhere |
| Queue Data | Causes of Delays | No queues in the model |
| Movements | List of Delays | Only one delay in the model |
| Entity Data | Lists of Entity Types & Delays² | Never |
| Entry Rules | Entity Data, Duration and Resources & | Maximum 1 inarc to every delay |
| | Movements | |
| Exit Rules | Entity Data, Duration and Resources & | Maximum 1 outarc from every |
| | Movements | delay |
| Transportation Data | Causes of Delays | No delay with {4} |
| Conveyor Data | Causes of Delays | No delay with {5} |
| Additional Tasks | List of Delays | Never |
| Symbols | All the above steps¹ | No expression in model |
| Common Resources | Duration and Resources | No common resource in model |

¹Predecessor in this case is not a compulsory requirement, only more logical. All the other predecessors are compulsory.
²Only first delay requires Lists of Delays, not other entity data. It is possible, therefore, to split this step to input of first delay as one step and other data as another step, while the other data needs only List of Entity Types as predecessor

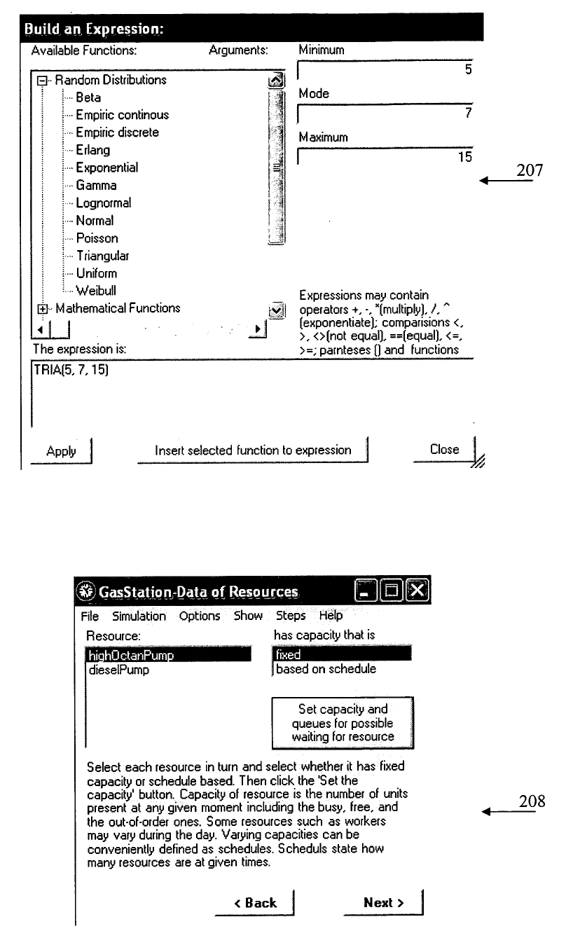

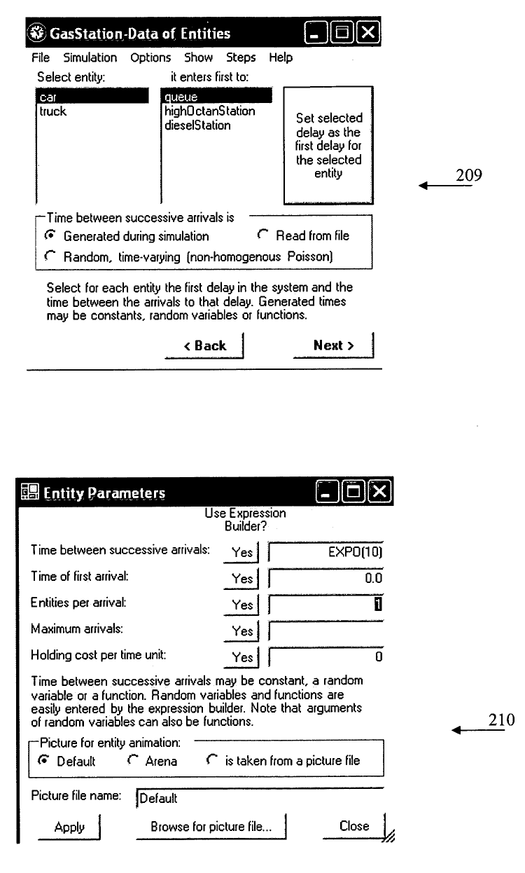

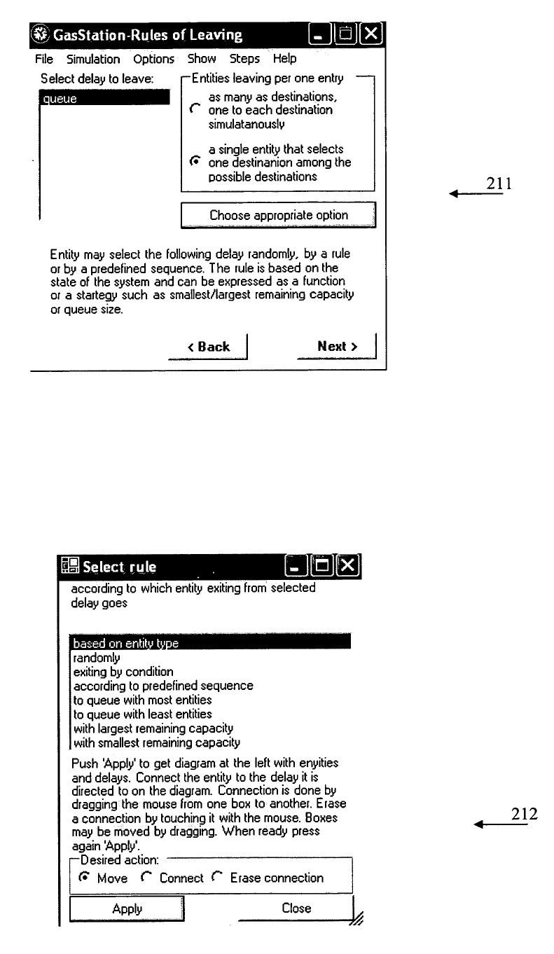

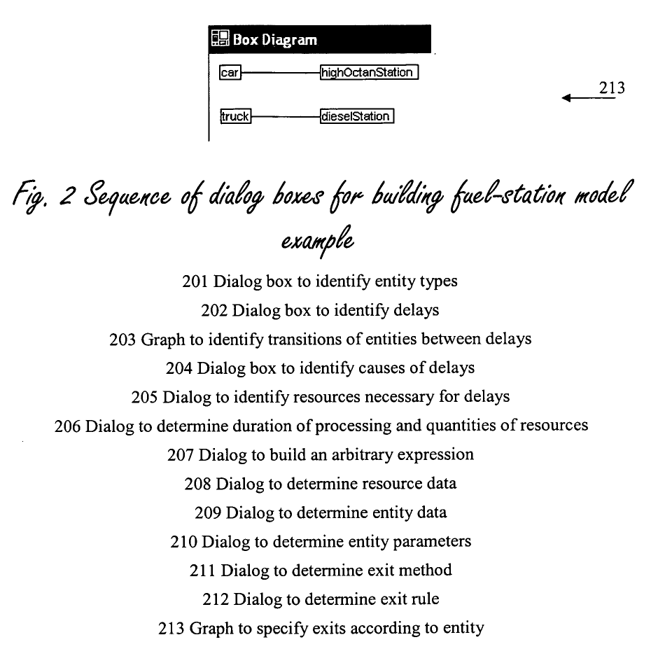

In the preferred embodiment the model is represented by a human-readable textual description which can be produced as output (printed or written to file). The same model that is human-readable also drives the simulation software. As an example take the case where cars and trucks arrive at a gas station to fill their tanks with gas (high octane for the cars and diesel for the truck) and get back onto the highway. There are three pumps in this gas station, two for high octane gas for the cars and one for diesel for the truck. For purposes of example, a possible sequence of dialog boxes used in building this model is shown in FIG. 2. The human-readable output for this model would be:

Basic Objects of Simulation

Entity Types that Pass Through the System
car//Randomly arriving, one car every 10 minutes on the average
truck//Randomly arriving, one car every 18 minutes on the average

Delays where Entities Wait
queue waits for resource to become free
highOctanStation waits for process (=activity) to end
dieselStation waits for process (=activity) to end

Resources for Processes
highOctanPump//Filling time is between 5 and 15 minutes, most probably 7 minutes
dieselPump//Filling time is between 10 and 15 minutes, most probably 15 minutes

Routing Entities Through Delays

Possible Moves between Connected Delays
from queue to highOctanStation
from queue to dieselStation

Rules for Exiting to next Delay
queue:based on entity type
car goes to highOctanStation
truck goes to dieselStation

Interaction between Objects

Entity Entries to Delays
car arrives at queue
truck arrives at queue

Resources for Process Delays
highOctanStation needs 1 units of highOctanPump
dieselStation needs 1 units of dieselPump

Delays where Resources are Seized:
highOctanPump that is used in highOctanStation is sized in queue
dieselPump that is used in dieselStation is sized in queue

Data of Entities
car: interarrival time is EXPO(10)
truck: interarrival time is EXPO(18)

Data of Delays
highOctanStation: duration is TRIA(5, 7, 15)
dieselStation: duration is TRIA(10, 12, 15)

Data of Resources
highOctanPump: number of available units is 2
dieselPump: number of available units is 1

Graphical Representation—Location of Delays
queue: X=10, Y=43
highOctanStation: X=115, Y=64
dieselStation: X=126, Y=25

Simulate model up to:

//Warm-up is the initial time units in each simulation

//during which observations are disregarded
1000 time units 1 times and warm-up 0

This human-readable output not only serves as an exact description of the modeled system but is used to drive the simulation.

In the preferred embodiment, automatic random number generation supporting the use of antithetic variables and the “common stream” method are included as an easily-accessed option, involving nothing more than indication in a single place that the user wants to use antithetic variables or the common-stream method. The method of antithetic variables involves pairwise simulations wherein one simulation is run with the random sequence (r₁, r₂, r₃, . . . ) and the second is run with the antithetic sequence (1-r₁, 1-r₂, 1-r₃, . . . ). The variance of the pair's average is less than the variance of the average of two independent sets of random numbers. In present systems the user has to modify many places in the model for the system to correctly make use of antithetic variables and/or common-stream techniques, and has to combine correctly the results to get averages with smaller variances. If the user forgets a place that requires such modification, the antithetic or common stream method does not work, and in some cases give more variance than simple simulations without. In the preferred embodiment the correct modifications and combination of results is made automatically.

The preferred embodiment also provides for automatic coding of names and hiding of remarks to solve the problem of secrecy.

In another embodiment of the invention, the system being built comprises a mathematical programming model instead of a discrete system simulation. In this case too, the correct model can be elicited from a naïve user by means of a set of questions.

The questions in this area are:
{1} list the dimensions of the problem
{2} list the elements of each dimension
{3} list all the requirements
{4} list the objective

For example, if we have 4 candidates with various abilities for 3 jobs and we want to maximize the overall fitness of the assignment of candidates to jobs, the verbal answers for these questions are:
{1} dimensions: jobs, candidates
{2} list of jobs: mechanic, inspector, aid to manager list of candidates: John, Mary, Peter, Alex
{3} list of requirements: for each job one candidate must be found; no candidate can fill two or more jobs
{4} objective: maximize sum of ability scores for the assignment.

In this case too, the system elicits the correct model formulation from a naïve user by means of a sequential set of questions asked of the user, the inclusion of said questions being dependent upon answers to preceding questions and thus context-sensitive. The invention thus provides for the correct entry of the rules of operation of a discrete system simulation, and/or a mathematical programming model, by a naïve user not versed in the encoding of such systems.

1. A method of building a discrete system simulation comprised of a finite set of steps taken from a closed list.

2. A method of building discrete system simulations, comprising a sequential set of questions asked of the author of the system, the inclusion of said questions being dependent upon answers to preceding questions and thus context-sensitive, wherein the model author is prompted for:
a. determining all possible entity types relevant for the simulation;
b. determining all possible delays that may occupy any of each of said entities;
c. determining all possible transitions of entities between the various delays, preferably but not necessarily denoted as directed arcs in a graph where the delays are the nodes;
d. determining the cause for each of the delays, said reasons being chosen from the following list of possible reasons:
{1} a process to end
{2} a resource to become free
{3} a condition to be satisfied
{4} a transporter to become free
{5} a vacant place on a conveyor
{6} batching
{7} synchronizing
{8} nothing—waiting indefinitely
{9} nothing—waiting 0 time
e. for all process-type delays, determining the duration of said processes and the necessary resources and quantities for completion of the processes, and disposing of resources on completion of a process;
f. for all resource-type delays, determining data pertaining to said resources, consisting of costs, availability of resources and delays in which resources are seized, possible breakdowns, breakdown durations, and rules of governing the breakdowns;
g. for all entities, determining data pertaining to the entity type, including arrival pattern, time of first arrival, holding costs, maximum arrivals, batch size, and representative icons for purposes of visualization and/or animation;
h. for each case in which more than one entity originating from different delays may enter a given delay, a rule regulating the choice of entity or combination of entities entering the given delay; in the case where one entity must be chosen to enter the delay said choice being either random, ordered, defined by a function, or based on queue length, and in the case where a combination of entities may enter a delay, whether said combination is permanent, temporary, or comprised of batching any or specific entities;
i. for each case where there exists a choice of subsequent delay upon completion of a given delay, rules regulating the choice of delay to take, said choice being based on entity type, predefined order, function evaluation, random choice, according to queue size if the destinations are queues, according to remaining capacities if the destination(s) are processes using resources, or indication that the entity is to be split and a copy sent to each possible subsequent delay;
j. for each case of waiting for a transporter to become free, information about the transporter such as possible routes, route lengths, speed(s), and carrying capacity;
k. for each case of waiting for a vacant place on a conveyor, information about the conveyor such as speed and carrying capacity;
l. determine additional tasks not deduced from the above steps, including provision for input, creation of output, creation and separation of temporary batches, terminating the stay of entities in delays, freeing resources seized in other delays and assigning values to quantities or attributes, said tasks being executed either prior to entering or after leaving a delay;
m. for all queue-type delays, namely waiting for a resource to become free, a condition to be satisfied, a transporter to become free, a vacant place on a conveyor, batching, or synchronizing, determine queue data including how entities are ordered in the queue such as first in-first out and other disciplines, capacity, and further information in cases of conditions, batching, and synchronizing;
n. define symbols representing attributes, constants, variables, functions, stochastic state variables, and/or Boolean or arithmetic expressions involving one or more of said symbols, wherein said variables may be scalars, vectors, or arrays, as well as starting values for constants and variables, allowing the simulation author to freely make use of said symbols in any of the preceding specifications; and,
o. determine rules for assigning priority in cases that more than one entity may request a common resource.

3. The method according to claim 2, comprising steps of implementing said sequence in software as an interactive process, especially a ‘wizard’ prompting the user to enter the appropriate information at every step, and skipping any steps that are irrelevant in view of earlier input; occurring in the presented order or other possible orders such as step (h) coming before step (e) or any other sequence consistent with the various steps' compulsory predecessors, and furthermore allowing for backtracking in the case of wrong or omitted data, and furthermore allowing for skipping to other parts.

4. A method of model building comprising steps of providing an engine as defined in claim 2, for a simplified, directed construction in logical top-down order of a model for simulation of a discrete-time system by a person who is familiar with the system to be simulated but who is not necessarily familiar with the building of simulations; said method comprising providing an engine for the conversion of a model created by a model-building apparatus to human-readable textual output that uniquely specifies the model, eliminating possible misunderstandings by the person familiar with the system to be simulated as to the contents of the model.

5. The method of model building and natural-language output apparatus of claim 2, comprising a step of obtaining a simulation engine for the simulation of the modeled system, and obtaining an engine for the exporting of said model to any number of standard formats allowing said model to be read and simulated by other simulator programs.

6. A method of discrete system model building and simulation of claim 2, additionally comprising a step of enabling provision for use of antithetic variables and “common stream” method as an easily-accessed option, involving only indication in a single place that the user wants to use antithetic variables or the common-stream method, and thereupon correctly and automatically placing in all relevant locations the proper seeds, and for the antithetic method correctly and automatically computing the relevant statistic.

7. A method of building a mathematical programming model that elicits the correct model formulation from a naïve user by means of a sequential set of questions asked of the user, the inclusion of said questions being dependent upon answers to preceding questions and thus context-sensitive.

8. A method of discrete system model-building and simulation according to claim 2, additionally comprising a step of providing for automatic encoding of names and hiding of remarks to satisfy the requirement for secrecy.

9. A finite set of steps taken from a closed list forming a discrete system simulation.

10. A sequence of steps for the building of discrete system simulations comprising a sequential set of questions asked of the author of the system, the inclusion of said questions being dependent upon answers to preceding questions and thus context-sensitive, wherein the model author is prompted to:
a. Determine all possible entity types relevant for the simulation;
b. Determine all possible delays that may occupy any of each of said entities;
c. Determine all possible transitions of entities between the various delays, preferably but not necessarily denoted as directed arcs in a graph where the delays are the nodes;
d. Determine the cause for each of the delays, said reasons being chosen from the following list of possible reasons:
{1} a process to end
{2} a resource to become free
{3} a condition to be satisfied
{4} a transporter to become free
{5} a vacant place on a conveyor
{6} batching
{7} synchronizing
{8} nothing—waiting indefinitely
{9} nothing—waiting 0 time
e. For all process-type delays, the duration of said processes and the necessary resources and quantities for completion of the processes, and disposition of resources on completion of a process;
f. For all resource-type delays, data pertaining to said resources, consisting of costs, availability of resources and delays in which resources are seized, possible breakdowns, breakdown durations, and rules of governing the breakdowns;
g. For all entities, data pertaining to the entity type, including arrival pattern, time of first arrival, holding costs, maximum arrivals, batch size, and representative icons for purposes of visualization and/or animation;
h. For each case in which more than one entity originating from different delays may enter a given delay, a rule regulating the choice of entity or combination of entities entering the given delay, in the case where one entity must be chosen to enter the delay said choice being either random, ordered, defined by a function, or based on queue length, and in the case where a combination of entities may enter a delay, whether said combination is permanent, temporary, or comprised of batching any or specific entities;
i. For each case where there exists a choice of subsequent delay upon completion of a given delay, rules regulating the choice of delay to take, said choice being based on entity type, predefined order, function evaluation, random choice, according to queue size if the destinations are queues, according to remaining capacities if the destination(s) are processes using resources, or indication that the entity is to be split and a copy sent to each possible subsequent delay;
j. For each case of waiting for a transporter to become free, information about the transporter such as possible routes, route lengths, speed(s), and carrying capacity;
k. For each case of waiting for a vacant place on a conveyor, information about the conveyor such as speed and carrying capacity;
l. Determine additional tasks not deduced from the above steps, including provision for input, creation of output, creation and separation of temporary batches, terminating the stay of entities in delays, freeing resources seized in other delays and assigning values to quantities or attributes, said tasks being executed either prior to entering or after leaving a delay;
m. For all queue-type delays, namely waiting for a resource to become free, a condition to be satisfied, a transporter to become free, a vacant place on a conveyor, batching, or synchronizing, determine queue data including how entities are ordered in the queue such as first in-first out and other disciplines, capacity, and further information in cases of conditions, batching, and synchronizing;
n. Define symbols representing attributes, constants, variables, functions, stochastic state variables, and/or Boolean or arithmetic expressions involving one or more of said symbols, wherein said variables may be scalars, vectors, or arrays, as well as starting values for constants and variables, allowing the simulation author to freely make use of said symbols in any of the preceding specifications, and
o. Determine rules for assigning priority in cases that more than one entity may request a common resource.

11. The sequence of steps of claim 10, implemented in software as an interactive process such as a ‘wizard’ prompting the user to enter the appropriate information at every step, and furthermore skipping any steps that are irrelevant in view of earlier input, furthermore occurring in the presented order or other possible orders such as step h coming before step e or any other sequence consistent with the various steps' compulsory predecessors, and furthermore allowing for backtracking in the case of wrong or omitted data, and furthermore allowing for skipping to other parts.

12. A model building apparatus comprising an engine for the simplified, directed construction in logical top-down order of a model for simulation of a discrete-time system by a person who is familiar with the system to be simulated but who is not necessarily familiar with the building of simulations, said apparatus furthermore comprising an engine for the conversion of the model created by the model-building apparatus to human-readable textual output that uniquely specifies the model, eliminating any misunderstandings by the person familiar with the system to be simulated as to the contents of the model.

13. The model building and natural-language output apparatus of claim 10 furthermore comprising a simulation engine for the simulation of the modeled system, as well as an engine for the exporting of said model to any number of standard formats allowing said model to be read and simulated by other simulator programs.

14. The discrete system model-builder and simulator of claim 10 furthermore allowing provision for the use of antithetic variables and the “common stream” method as an easily-accessed option, involving only indication in a single place that the user wants to use antithetic variables or the common-stream method, correctly and automatically places everywhere the seeds and for the antithetic method correctly and automatically computing the relevant statistic.

15. The discrete system model-builder and simulator of claim 10 additionally providing for automatic encoding of names and hiding of remarks to satisfy the requirement for secrecy.
